(19) United States
(12) Patent Application Publication
(10) Pub. No.: US 2009/0135337 A1
(43) Pub. Date: May 28, 2009

(54) LIQUID CRYSTAL DISPLAY

(75) Inventors: Chun-Chieh Wang, Hsinchu (TW); Chen-Hsien Liao, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AU OPTRONICS CORPORATION, Hsinchu (TW)

(21) Appl. No.: 12/046,475

(22) Filed: Mar. 12, 2008

(30) Foreign Application Priority Data
Nov. 28, 2007 (TW) 96145183

(51) Int. Cl. G02F 1/13357

(52) U.S. Cl. 349/65; 349/70

(57) ABSTRACT

A liquid crystal display (LCD) including a backlight module and a LCD panel is provided. The backlight module has at least one white light source. BL₁ and BL₂ respectively represent a relative maximum brightness peak of an emission spectrum of the backlight module at a wavelength from 445 nm to 448 nm and from 510 nm to 520 nm. The LCD panel including two substrates and a liquid crystal layer sandwiched between the two substrates is disposed above the backlight module. One of the two substrates has a red filter layer, a green filter and a blue filter layer. Specially, Gₓ represents an x coordinate in a CIE 1931 chromaticity diagram when the green filter layer uses a CIE standard light source C, and Gₓ is larger than or equal to 0.286 (Gₓ≧20.286).

### CROSS-REFERENCE TO RELATED APPLICATION

This application claims the priority benefit of Taiwan application serial no. 96145183, filed on Nov. 28, 2007. The entirety the above-mentioned patent application is hereby incorporated by reference herein and made a part of specification.

### BACKGROUND OF THE INVENTION

1. Field of the Invention

The present invention generally relates to a display, and more particularly, to a liquid crystal display (LCD).

2. Description of Related Art

LCDs featuring favorable display quality, great space utilization, low power consumption and non-radiation have become prevailing displays little by little. One of the determinative factors of purchasing the widespread LCDs is color reproduction, and thus various techniques to achieve high color reproduction have been proposed for satisfying consumers' demands.

The LCD mainly includes an LCD panel and a backlight module providing a light source to the LCD panel. The LCD panel includes, for example, an active device array substrate, a color filter substrate, and a liquid crystal layer sandwiched therebetween, wherein the color filter substrate has a red filter layer, a green filter layer, and a blue filter layer. In general, the light source provided by the backlight module may adopt a cold-cathode fluorescent lamp (CCFL), a light emitting diode (LED), or other light sources. Here, the CCFL serving as a white light source of the backlight module is taken as an example. An NTSC ratio representing color saturation of the normal LCD approximately reaches 70%˜75% at this current stage. Said NTSC ratio is a standard instituted by National Television System Committee (NTSC) for measuring color saturation. On the other hand, Adobe specification is generally taken by people skilled in the pertinent art as a reference for color adjustment when the red saturation, green saturation, and blue saturation are adjusted. As indicated in a CIE 1931 chromaticity coordinate diagram, the red chromaticity coordinates, green chromaticity coordinates, and blue chromaticity coordinates are respectively represented as red specification (Rₓ, R_{y})=(0.640, 0.330), green specification (Gₓ, G_{y})=(0.210, 0.710), and blue specification (Bₓ, B_{y})=(0.150, 0.060).

In order to improve color saturation of the LCD, U.S. Publication Application No. 20070058105 proposes an LCD 10 using the CCFL as the backlight module. FIG. 1 is a schematic plot illustrating chromaticity coordinates of the LCD 10. Referring to FIG. 1, the LCD 10 achieves desired color saturation rather than a conventional LCD does. Nevertheless, some drawbacks have been brought up when the LCD 10 aims at improving blue saturation and green saturation. In detail, BaMgAl10:Eu is employed as a blue phosphor of the CCFL of the LCD 10, while BaMgAl10:Eu,Mn is adopted as a green phosphor of the CCFL. A light emission spectrum of the backlight module has a relative maximum brightness peak intensity at a wavelength of approximately 450 nm by using blue phosphor BaMgAl₁₀:Eu, while another relative maximum brightness peak intensity at a wavelength from 510 nm to 520 nm by using green phosphor BaMgAl10:Eu,Mn.

In the case where BaMgAl₁₀:Eu is adopted as the blue phosphor of the backlight module, the blue chromaticity coordinate Bₓ of the LCD 10 is of a relatively small value. Hence, Bₓ should be increased by adding violet pigments in a corresponding blue filter layer, so as to reach the standard chromaticity of the blue specification (Bₓ, B_{y})=(0.150, 0.060) as set forth in the Adobe specification. However, adding excessive violet pigments often gives rise to a reduced contrast of the LCD. Moreover, the use of the violet pigments, in most cases, deteriorates heat resistance and chemical resistance. By contrast, notwithstanding the improved color saturation of the backlight module due to using BaMgAl10:Eu,Mn as the green phosphor, the green chromaticity coordinate Gₓ of the LCD 10 is still of an insufficient value. In other words, green saturation of the LCD 10 is barely satisfactory.

### SUMMARY OF THE INVENTION

In light of the foregoing, the present invention is directed to an LCD simultaneously improving color saturation and saturation of monochromatic primaries, e.g. blue saturation and green saturation.

To embody the present invention, an LCD including a backlight module and an LCD panel is provided herein. BL₁ and BL₂ respectively represent a relative maximum brightness peak of an emission spectrum of the backlight module at a wavelength from 445 nm to 448 nm and from 510 nm to 520 nm. The LCD panel including two substrates and a liquid crystal layer sandwiched therebetween, wherein one of the two substrates has a red filter layer, a green filter layer and a blue filter layer. Specially, Gₓ represents an x coordinate in a CIE 1931 chromaticity diagram when the green filter layer uses a CIE standard light source C. Here, Gₓ is larger than or equal to 0.286 (Gₓ≧0.286).

According to an embodiment of the present invention, the backlight module includes a direct type backlight module or an edge-light type backlight module.

According to an embodiment of the present invention, the white light source includes a CCFL, and an inner wall of the CCFL is equipped with a plurality of phosphor materials including red phosphor, green phosphor, and blue phosphor. According to an embodiment of the present invention, the blue phosphor includes Sr₅(PO₄)₃CL:Eu, while the green phosphor includes BaMgAl₁₀:Eu,Mn.

According to an embodiment of the present invention, the two substrates include a thin film transistor (TFT) array substrate and a color filter substrate. According to another embodiment of the present invention, the two substrates include a color filter on array (COA) substrate and an opposite substrate having a common electrode. According to still another embodiment of the present invention, the two substrates include an array on color filter (AOC) substrate and an opposite substrate having a common electrode.

In light of the foregoing, through controlling the distribution of the relative maximum brightness peak intensity in the emission spectrum of the backlight module and through adjusting the emission spectrum of the corresponding color filter layer, the blue saturation and the green saturation achieved by the LCD of the present invention can be boosted.

In order to the make the aforementioned and other objects, features and advantages of the present invention comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic plot illustrating chromaticity coordinates of a conventional LCD.

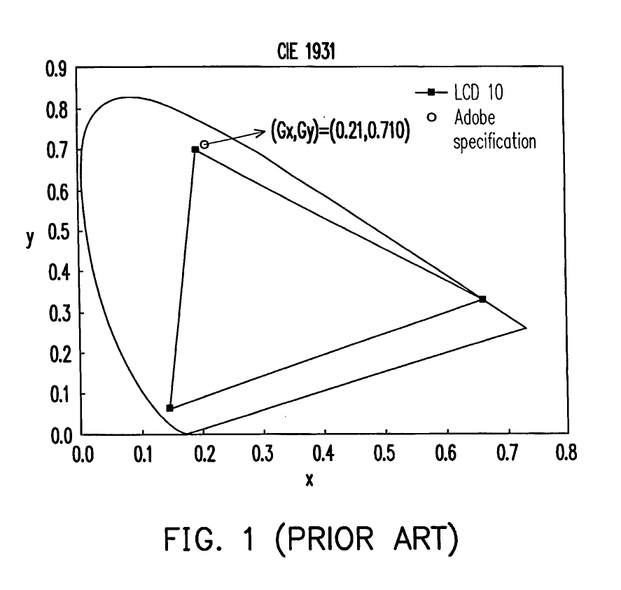

FIG. 2 is a schematic view illustrating an LCD according to the present invention.

FIG. 3 is a CIE 1931 chromaticity diagram by which the LCD of the present invention is compared with a conventional LCD.

### DESCRIPTION OF EMBODIMENTS

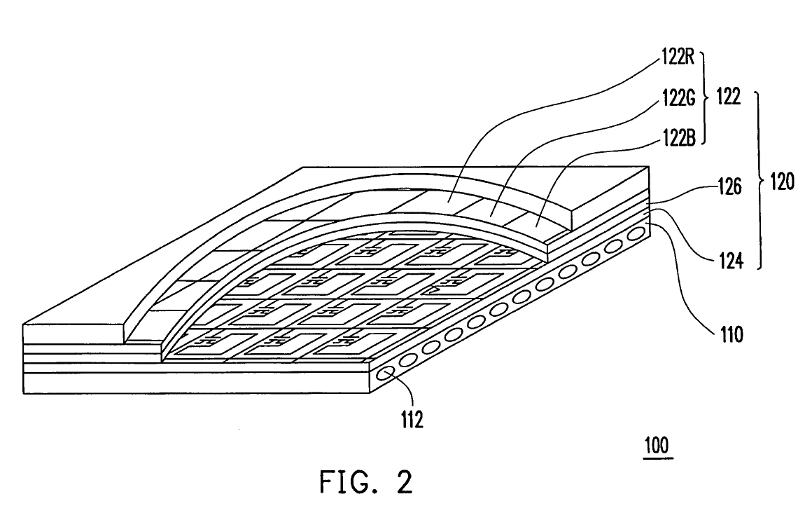

FIG. 2 is a schematic view illustrating an LCD according to the present invention. Referring to FIG. 2, an LCD 100 includes a backlight module 110 and an LCD panel 120. The backlight module 110 is, for example, a direct type backlight module or an edge-light type backlight module. Further, the backlight module 110 has at least one white light source 112. In the present embodiment, a CCFL is utilized for exemplifying the white light source 112.

Specifically, an inner wall of the white light source 112 is equipped with a plurality of phosphor materials including red phosphor, green phosphor, and blue phosphor, for example, so as to modulate optical characteristics of the white light source 112, such as luminance, chromaticity, and so on. In addition, color saturation of the phosphors is a key factor determining the entire chromaticity performance. Here, the white light source 112 in the LCD 100 employs Sr₅(PO₄)₃CL:Eu as the blue phosphor, such that an emission spectrum of the backlight module 110 at the wavelength from 445 nm to 448 nm has a relative maximum brightness peak BL₁. On the other hand, the white light source 112 in the LCD 100 utilizes BaMgAl10:Eu as the green phosphor, such that the emission spectrum of the backlight module 110 at the wavelength from 510 nm to 520 nm has a relative maximum brightness peak intensity BL₂.

Referring to FIG. 2, the LCD panel 120 is disposed above the backlight module 110 and includes two substrates and a liquid crystal layer 126 sandwiched between the two substrates. As indicated in FIG. 2, the two substrates are, for example, a TFT array substrate 124 and a color filter substrate 122 having a red filter layer 122R, a green filter layer 122G, and a blue filter layer 122B. It is of certainty that the two substrates can also be a COA substrate and an opposite substrate having a common electrode according to another embodiment. Alternatively, the two substrates are an AOC substrate and an opposite substrate having a common electrode. Note that when the green filter layer 122G is measured by using a CIE standard light source C, Gₓ representing a green color coordinate in a CIE 1931 chromaticity diagram is larger than or equal to 0.286 (Gₓ≧0.286).

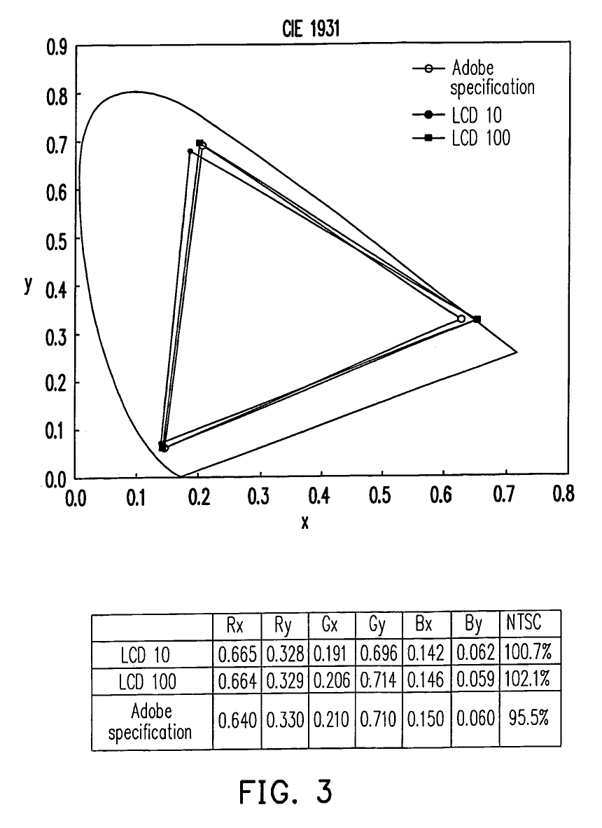

FIG. 3 is a CIE 1931 chromaticity diagram by which the LCD of the present invention is compared with a conventional LCD. Referring to FIG. 3, the conventional LCD 10 and the LCD 100 of the present embodiment are distinguishable in terms of the blue saturation and the green saturation as indicated in the chromaticity diagram. In detail, an appropriate blue phosphor and an appropriate green phosphor are employed in the backlight module 110 of the LCD 100. Thereby, the emission spectra of the backlight module 110 at the wavelengths from 445 nm to 448 nm and from 510 nm to 520 nm have the relative maximum brightness peak intensity BL₁ and BL₂, respectively. On the other hand, Gₓ denoting the x coordinate of the green filter layer 122G in the LCD panel 120 satisfies a certain condition: Gₓ≧0.286. As shown in FIG. 3, when the LCD panel 120 and the backlight module 110 satisfying the aforesaid condition are together adopted in the LCD 100, an NTSC ratio of the LCD 100 substantially reaches 102.1%, which is greater than the NTSC ratio of the conventional LCD 10 substantially attaining to 100.7%. Moreover, the LCD 100 accomplishes superior blue saturation and green saturation. Data will be provided hereinafter for further elaborating the blue saturation and the green saturation.

Particularly, in the case where BaMgAl₁₀:Eu is adopted as the blue phosphor of the backlight module in the conventional LCD 10, a blue chromaticity coordinate Bₓ of the conventional LCD 10 in the chromaticity diagram is substantially 0.142. By contrast, Sr₅(PO₄)₃CL:Eu is utilized as the blue phosphor of the backlight module 110 according to the present embodiment, such that the blue chromaticity coordinate Bₓ of the LCD 100 in the chromaticity diagram substantially reaches 0.146. Namely, with reference to the Adobe specification, the blue specification (Bₓ, B_{y})=(0.150, 0.060) in the CIE 1931 chromaticity diagram. Hence, the blue chromaticity coordinate Bₓ of the LCD 100 is rather close to the standard value 0.150 regulated by the Adobe specification in which the standardized chromaticity of the blue light is defined. That is to say, as the emission spectrum of the backlight module 110 at the wavelength from 445 nm to 448 nm has the relative maximum brightness peak intensity BL₁, the blue saturation accomplished by the LCD 100 is comparatively favorable in comparison with that achieved by the LCD 10.

On the other hand, with reference to the Adobe specification, the green specification (Gₓ, G_{y})=(0.210, 0.710) in the CIE 1931 chromaticity diagram. In the present embodiment, BaMgAl₁₀:Eu,Mn is adopted as the green phosphor of the backlight module 110, for example, such that the emission spectrum of the backlight module 110 at the wavelength from 510 nm to 520 nm has a relative maximum brightness peak intensity BL₂. It should be noted that the green saturation of the LCD 100 is significantly improved merely by simultaneously monitoring the green emission spectrum of the backlight module 110 and by taking performance of the corresponding green filter layer 122G into consideration when adjustment is made for improving the green saturation.

For instance, as depicted in FIG. 3, the backlight module 110 of the LCD 100 in the present embodiment is similar to the backlight module of the LCD 10, and the emission spectra of said two backlight modules at the wavelength from 510 nm to 520 nm both have the relative maximum brightness peak intensity BL₂. However, note that in the present embodiment, the LCD panel 120 of the LCD 100 is different from that of the conventional LCD 10. When the green filter layer 122G of the LCD panel 120 uses the CIE standard light source C, Gₓ representing the x coordinate in the CIE 1931 chromaticity diagram satisfies a certain condition: Gₓ≧0.286. As the LCD panel 120 and the backlight module 110 are employed at the same time, the green coordinate Gₓ of the LCD 100 shifts from 0.191 up to 0.206 substantially, which is rather close to the Adobe specification in which Gₓ reaches 0.210. Namely, the green saturation of the LCD 100 can only be improved in an effective manner by simultaneously taking the distribution of the emission spectrum of the backlight module 110 and chromaticity performance of the corresponding green filter layer 122G into account.

To sum up, the distribution of the relative maximum brightness peak intensity in the emission spectrum of the backlight module is modulated in the LCD of the present invention, and the green filter layer satisfying the certain condition is also adopted in the present invention. Thereby, as a result, the blue saturation and the green saturation of the LCD can be boosted together with the color saturation as a whole.

Although the present invention has been disclosed above by the embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. A liquid crystal display, comprising:
a backlight module having at least one white light source, wherein BL₁ and BL₂ respectively represent a relative maximum brightness peak of an emission spectrum of the backlight module at a wavelength from 445 nm to 448 nm and from 510 nm to 520 nm; and
a liquid crystal display panel disposed above the backlight module, the liquid crystal display panel having two substrates and a liquid crystal layer sandwiched therebetween, wherein one of the two substrates has a red filter layer, a green filter layer and a blue filter layer, and Gₓ represents an x coordinate in a CIE 1931 chromaticity diagram when the green filter layer uses a CIE standard light source C, and Gₓ is larger than or equal to 0.286 (Gₓ≧0.286).

2. The liquid crystal display as claimed in claim 1, wherein the backlight module comprises a direct type backlight module or an edge-light type backlight module.

3. The liquid crystal display as claimed in claim 1, wherein the white light source comprises a cold-cathode fluorescent lamp.

4. The liquid crystal display as claimed in claim 3, wherein an inner wall of the cold-cathode fluorescent lamp is equipped with a plurality of phosphor materials.

5. The liquid crystal display as claimed in claim 4, wherein the phosphor materials comprise red phosphor, green phosphor, and blue phosphor.

6. The liquid crystal display as claimed in claim 5, wherein the blue phosphor comprises Sr₅(PO₄)₃CL:Eu.

7. The liquid crystal display as claimed in claim 5, wherein the green phosphor comprises BaMgAl₁₀:Eu,Mn.

8. The liquid crystal display panel as claimed in claim 1, wherein the two substrates comprise a thin film transistor array substrate and a color filter substrate.

9. The liquid crystal display panel as claimed in claim 1, wherein the two substrates comprise a color filter on array substrate and an opposite substrate having a common electrode.

10. The liquid crystal display panel as claimed in claim 1, wherein the two substrates comprise an array on color filter substrate and an opposite substrate having a common electrode.
